(19) United States
(12) Patent Application Publication
(10) Pub. No.: US 2010/0117010 A1
(43) Pub. Date: May 13, 2010

(54) SYSTEM FOR MEASURING THE WRINKLE ON WEB IN R2R PROCESS

(75) Inventors: Sung Lim Ko, Seoul (KR); Dong Keun Shin, Seoul (KR); Hoang Minh To, Seoul (KR); Kee Hyun Shin, Gyeonggi-do (KR)

Correspondence Address: MAIER & MAIER, PLLC, 1000 DUKE STREET, ALEXANDRIA, VA, 22314, US

(73) Assignee: Konkuk University Industrial Cooperation Corp., Seoul (KR)

(21) Appl. No.: 12/596,469

(22) PCT Filed: Jun. 20, 2008
(86) PCT No.: PCT/KR08/03520

§ 371 Date: Oct. 19, 2009

(30) Foreign Application Priority Data
Jun. 20, 2007 (KR) 10-2007-0060753

(51) Int. Cl. G01N 21/86

(52) U.S. Cl. 250/559.05; 356/430

(57) ABSTRACT

The present invention relates to a system for measuring wrinkles on a web in an R2R process. The system includes a laser generation device (100) for projecting a laser beam, emitted in a linear shape, onto a surface of a web (200), which is stopped or moving. A camera (300) captures a band of light, formed when the laser beam generated by the laser generation device (100) is projected onto the surface of the web (200), and transmitting image data of the captured light band. A measurement device (400) calculates coordinates of an arbitrary location on the web (200) on a basis of the image data transmitted from the camera (300), processes an image of the light band on a basis of the calculated coordinates, and displays the processed image. Accordingly, the results of reliable wrinkle measurement are provided for a web in an R2R process.

### TECHNICAL FIELD

The present invention relates, in general, to a system for measuring a wrinkle on a web in a Roll-to-Roll (R2R) process, and, more particularly, to a system for measuring wrinkles on a web in an R2R process, which captures an image obtained when a linear laser beam passes through a web, calculates three-dimensional shape information, including the height of a wrinkle on the web, on the basis of the captured image data, and displays an image for the shape information of the web in real time.

### BACKGROUND ART

Recently, research on and development of Radio Frequency Identification (RFID) or flexible display fields have been actively conducted all over the world.

Such an RFID is a non-contact recognition system for transmitting and processing information about objects or surrounding environments using a small-sized semiconductor chip, and is evaluated as technology for replacing a barcode in that direct contact or scanning is not required. Further, a flexible display is a display device that can be folded or rolled due to the flexible material thereof, and includes a Thin Film Transistor (TFT) Liquid Crystal Display (LCD), an Organic Light Emitting Diode (OLED), etc. For such a flexible display, electrophoresis technology, Laser Induced Thermal Image (LITI) technology, etc. are used.

The material of the electronic parts, used in the above-described RFID or flexible display fields, may frequently include a web. The manufacture of the web can be performed through a Roll-to-Roll (R2R) process to reduce manufacturing costs. In such an R2R process, defects or impurities on the surface of a web must be suppressed. In particular, as shown in FIG. 1, effective measurement is required to prevent wrinkles on the web.

In the prior art, most research into the improvement of precision or productivity in the R2R process has been conducted with the goal of suppressing defects or impurities on the surface of a web. Methods of measuring wrinkles on the web to prevent wrinkles thereon include a laser triangulation method, and a method using both a line scan camera and a front lighting scheme.

However, such a laser triangulation method is problematic in that, since most laser beams pass through a web, the reliability of measurement results is low, and the laser triangulation method is only partially applied due to the high web speed in an R2R process.

Meanwhile, the method using both a line scan camera and a front lighting scheme is problematic in that it is difficult to precisely measure information about the actual shape of wrinkles and it is impossible to measure the height of the wrinkles.

### DISCLOSURE

### Technical Problem

An object of the present invention is to provide a system for measuring wrinkles, which can be applied to a web that is moving at high speed in an R2R process, and can improve reliability of the R2R process.

Another object of the present invention is to provide a system for measuring wrinkles, which can measure wrinkles on a web using three-dimensional coordinates, including a height coordinate, in an R2R process.

A further object of the present invention is to provide a system for measuring wrinkles, which can display the results of measurements of shape information of wrinkles on a web in real time in an R2R process.

### Technical Solution

Prior to the description of the construction of the present invention, it should be noted that components, not directly related to the gist of the present invention, are omitted within a range in which the gist of the present invention is not changed.

In order to accomplish the above objects, the present invention provides a system for measuring wrinkles on a web in a Roll-to-Roll (R2R) process, comprising a laser generation device (100) for projecting a laser beam, emitted in a well defined line shape, onto a surface of a web, which is stopped or moving; a camera for capturing a band of light, formed when the laser beam generated by the laser generation device is projected onto the surface of the web, and transmitting image data of the captured light band; and a measurement device for calculating coordinates of an arbitrary location on the web on a basis of the image data transmitted from the camera, processing an image of the light band on a basis of the calculated coordinates, and displaying the processed image.

Preferably, the laser beam may be a diode laser beam.

Preferably, the laser beam may be projected in a direction perpendicular to the surface of the web.

Preferably, the system may further comprise a background element installed opposite the laser generation device around the surface of the web and configured to block information unnecessary for measurement of a wrinkle on the web.

Preferably, the measurement device may comprise a coordinate measurement unit for collecting image data from the camera using internal measurement software, calculating three-dimensional coordinates at a measurement location using the collected image data, and forming the image of the light band; an image processing unit for removing noise from the image of the light band, thus clarifying the image; an image correction unit for correcting a distorted region of the image, from which the noise is removed and which is clarified; and a display unit for displaying the image, in which the distorted region is corrected.

Preferably, the image processing unit may remove noise from the image of the light band using a Sobel operator represented by a separable 3×3 matrix, as shown in the following equation, thus clarifying the image:

$$f ( x , y ) = [ \begin{matrix}- 1 & - 2 & - 1 \\ 0 & 0 & 0 \\ 1 & 2 & 1\end{matrix} ] = [ \begin{matrix}- 1 \\ 0 \\ 1\end{matrix} ] \times [ \begin{matrix}1 & 2 & 1\end{matrix} ] = g ( x ) \times h ( y )$$

Preferably, the calculation of coordinates performed by the measurement device may be performed using a one step procedure.

Preferably, the one step procedure may be performed by the following equations:

$$[ \begin{matrix}{u}^{2} & {v}^{2} & uv & u & v & 1\end{matrix} ] M = z \\ [ \begin{matrix}u & v & 1\end{matrix} ] N = y \\ [ \begin{matrix}{z}_{1} \\ … \\ {z}_{i} \\ … \\ {z}_{n}\end{matrix} ] = [ \begin{matrix}{u}_{1}^{2} & {v}_{1}^{2} & {u}_{1} {v}_{1} & {u}_{1} & {v}_{1} & 1 \\ … & … & & & & \\ {u}_{i}^{2} & {v}_{i}^{2} & {u}_{i} {v}_{i} & {u}_{i} & {v}_{i} & 1 \\ … & … & & & & \\ {u}_{n}^{2} & {v}_{n}^{2} & {u}_{n} {v}_{n} & {u}_{n} & {v}_{n} & 1\end{matrix} ] \vert \begin{matrix}\begin{matrix}{m}_{1} \\ …\end{matrix} \\ {m}_{c}\end{matrix} \vert$$

where z is a height of the wrinkle on the web, y is a distance in a coordinate system, set on the surface of the web, in a direction perpendicular to a movement direction of the web, zᵢ, uᵢ and vᵢ are three-dimensional coordinates set by a correction platform based on the one step procedure.

Preferably, the image correction unit may compensate for curvatures of the image, from which the noise is removed and which is clarified, by applying a Gaussian filter to the image.

Preferably, a Gaussian regression filter is used to correct a twisted distortion after the Gaussian filter has been applied.

### DESCRIPTION OF DRAWINGS

FIG. 1 is a diagram showing an example of a wrinkle formed on the surface of a web;

FIG. 2 is a diagram showing the overall construction of a system for measuring wrinkles on a web according to an embodiment of the present invention;

FIG. 3 is a schematic diagram showing a system for measuring wrinkles on a web according to an embodiment of the present invention;

FIG. 4 is a diagram showing an example of a band of light formed on the section of a web by a laser beam;

FIG. 5 is a diagram showing a correction platform according to an embodiment of the present invention;

FIG. 6 is a diagram showing an example of a display screen obtained through measurement software;

FIG. 7 is a diagram showing an example of an image before a Sobel operator is applied;

FIG. 8 is a diagram showing an example of an image after a Sobel operator is applied;

FIG. 9 is a diagram showing an example of an image before Gaussian regression filtering is applied;

FIG. 10 is a diagram showing an example of an image after Gaussian regression filtering is applied;

FIG. 11 is a diagram showing a bitmap image according to an embodiment of the present invention; and

FIG. 12 is a diagram showing a distribution of the heights of wrinkles according to an embodiment of the present invention.

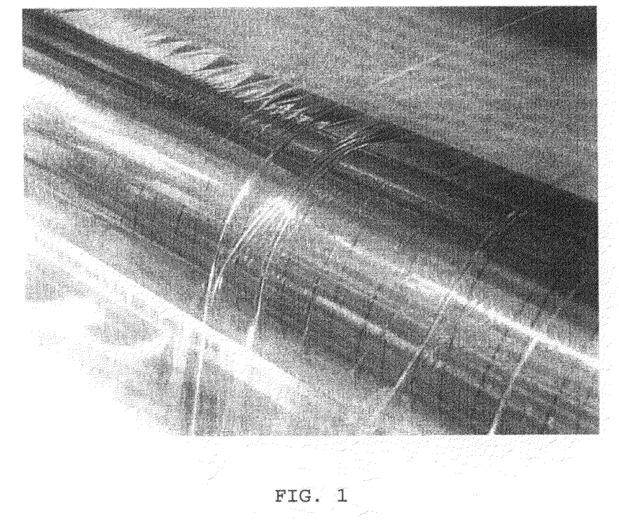

### BEST MODE

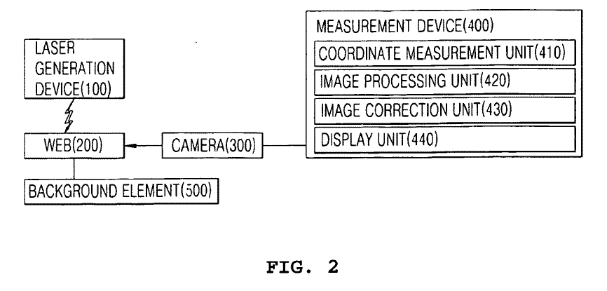

Hereinafter, the overall construction of a system for measuring wrinkles according to an embodiment of the present invention will be described with reference to FIGS. 2 to 12.

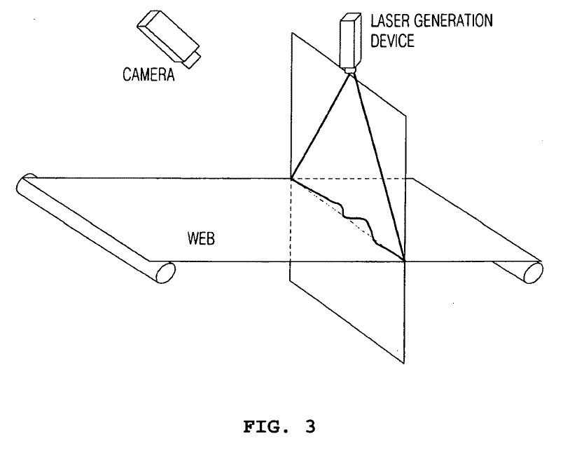

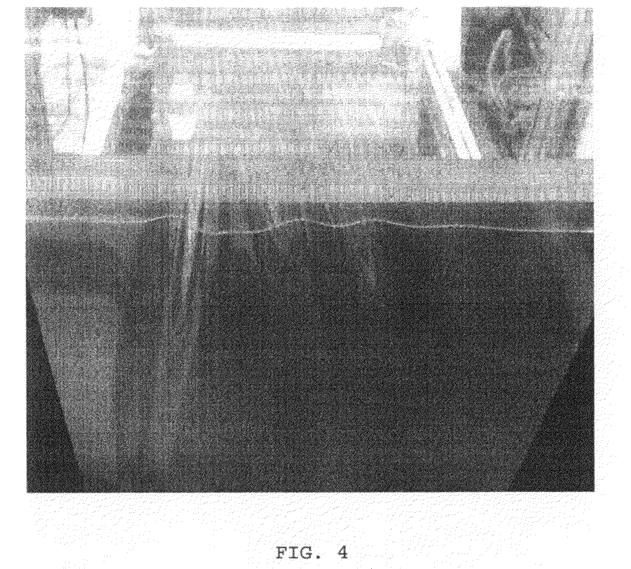

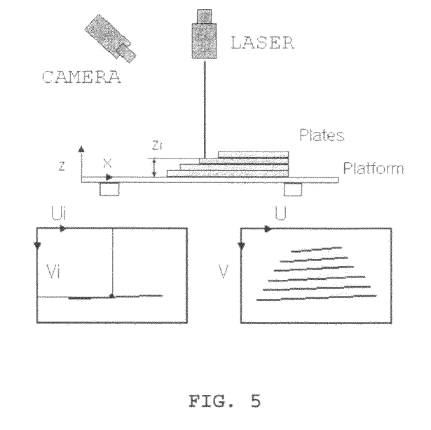

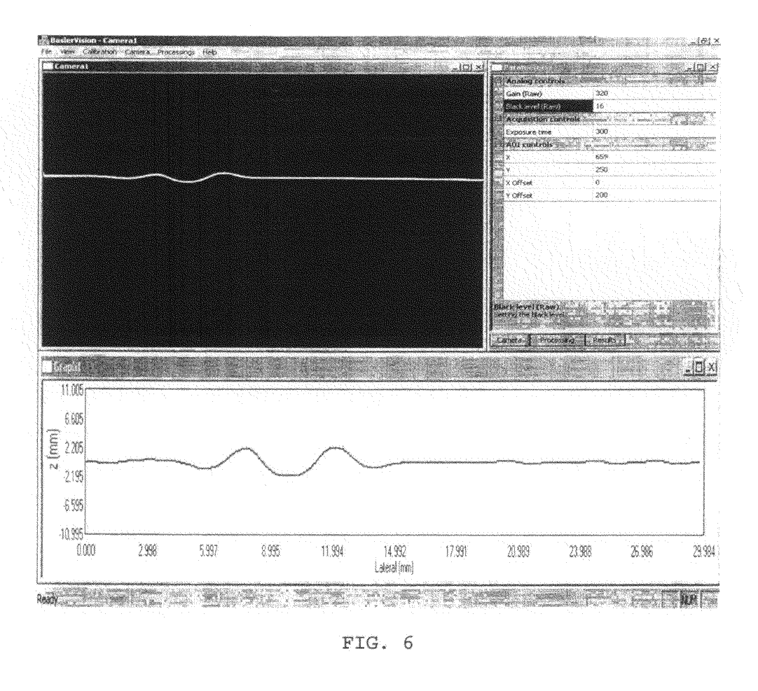

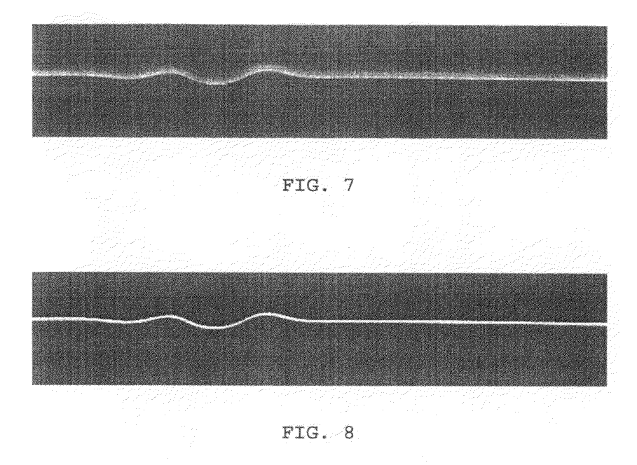

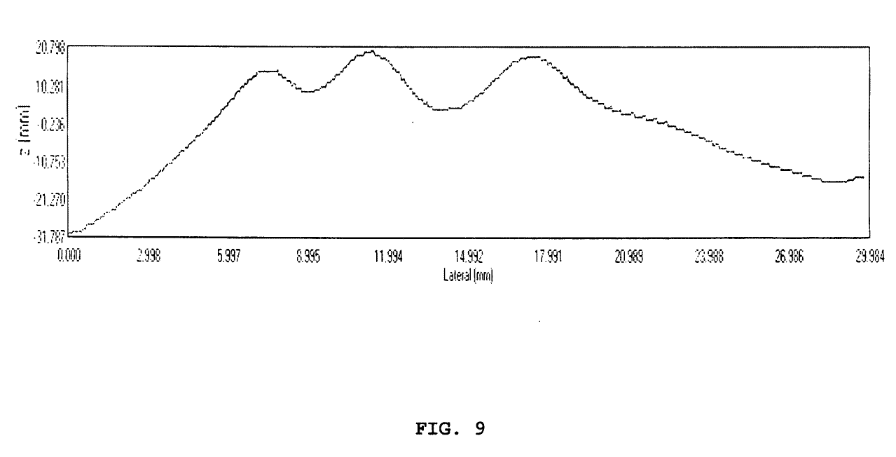

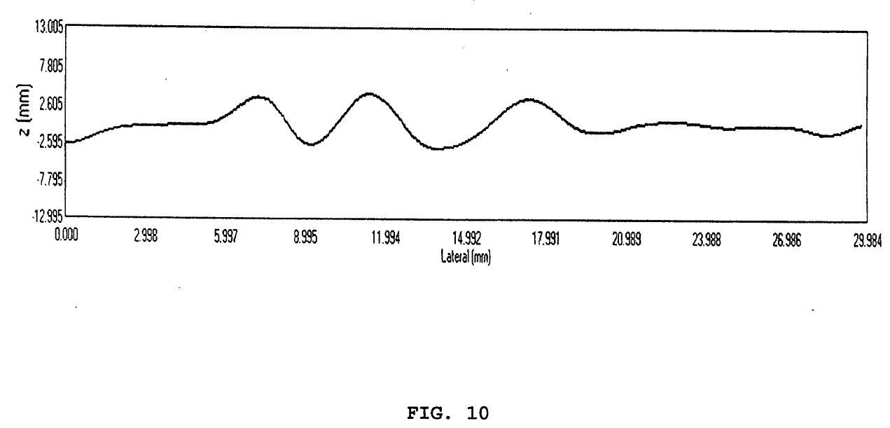

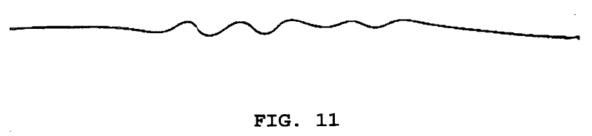

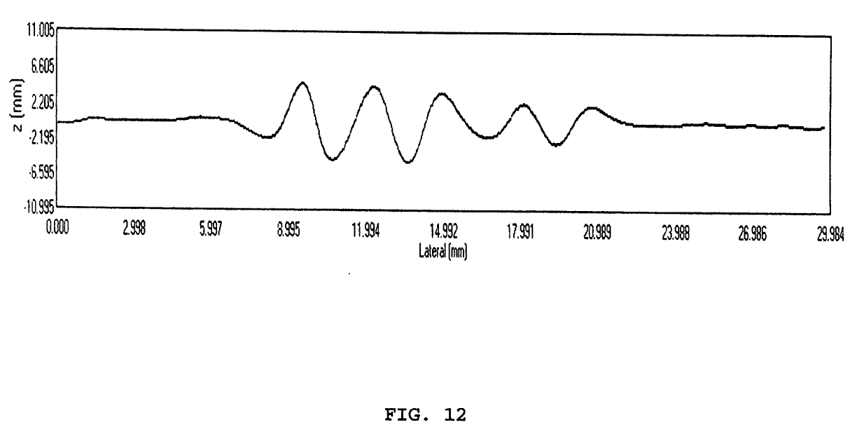

FIG. 2 is a diagram showing the overall construction of a system for measuring wrinkles on a web according to an embodiment of the present invention, FIG. 3 is a schematic diagram showing a system for measuring wrinkles on a web according to an embodiment of the present invention, FIG. 4 is a diagram showing an example of a band of light formed on the section of a web by a laser beam, FIG. 5 is a diagram showing a correction platform according to an embodiment of the present invention, FIG. 6 is a diagram showing an example of a display screen obtained through measurement software, FIG. 7 is a diagram showing an example of an image before a Sobel operator is applied, FIG. 8 is a diagram showing an example of an image after a Sobel operator is applied, FIG. 9 is a diagram showing an example of an image before Gaussian regression filtering is applied, FIG. 10 is a diagram showing an example of an image after Gaussian regression filtering is applied, FIG. 11 is a diagram showing a bitmap image according to an embodiment of the present invention, and FIG. 12 is a diagram showing a distribution of the heights of wrinkles according to an embodiment of the present invention.

As shown in FIG. 2, the system for measuring wrinkles according to an embodiment of the present invention includes a laser generation device 100, a web 200, a camera 300, a measurement device 400, and a background element 500.

The laser generation device 100 generates a laser beam in the shape of a line, rather than a point. As shown in FIG. 3, the generated laser beam is projected onto the surface of a web, which is stopped or moving, in an R2R process. The angle which the laser beam makes with respect to the surface of the web can be variously set, but may be preferably set to a right angle. Preferably, the laser beam generated by the laser generation device 100 may be a diode laser beam.

When the laser beam is projected onto the surface of the web, some of the laser beam passes through the web, and the remaining laser beam, which does not pass through the web, forms a band of light on the section of the web, whereby the measurement of the wrinkles is possible. The light band appears as a linear shape when a wrinkle is not formed, and appears along the section of a wrinkle when a wrinkle is formed, as shown in FIG. 4.

Further, the web 200 is manufactured to be used as the material for various electronic parts in an R2R process, and is manufactured through a rolling process using a web roller. The web 200 can be manufactured to have various transparencies according to the purpose thereof, etc. In the wrinkle measurement method according to an embodiment of the present invention, a transparency of 80% is assumed.

Further, the camera 300 captures an image in the light band, formed when the laser beam generated by the laser generation device 100 is projected onto the surface of the web, and transmits the captured image to the measurement device 400. The camera 300 can be designated to have various resolutions and pixel sizes according to the performance required for measurement, but, in a preferred embodiment of the present invention, a Basler Scout sc3640-74 gm, having a resolution of 659×494 and a pixel size of 10 μm, was used. The Basler Scout sc3640-74 gm can capture monochrome images at the speed of 79 frames per second when the maximum resolution is used.

Further, the measurement device 400 functions to calculate the coordinates of an arbitrary location on the captured web 200 on the basis of the data transmitted from the camera 300, clarify an image of the light band on the basis of the calculated coordinates, correct the distortion of the clarified image, and display the distortion-corrected image.

The measurement device 400 includes a coordinate measurement unit 410, an image processing unit 420, an image correction unit 430, and a display unit 440.

The coordinate measurement unit 410 obtains a height z, and a y coordinate value from the image coordinates (u, v) of the arbitrary location on the web 200, received from the camera 300, and measures three-dimensional coordinates of which the x coordinate value indicating the movement direction of the web is added to the z and y coordinates.

Hereinafter, the measurement of three-dimensional coordinates performed by the coordinate measurement unit 410 is described in detail below.

Typical coordinate measurement is performed independently on a camera and on a laser beam projector by approximating respective coordinate systems thereon. However, the wrinkle measurement apparatus according to an embodiment of the present invention assumes a single coordinate system for both the laser generation device 100 and the camera 300.

The measurement of coordinates was conducted using a one step procedure, which is proposed by De Piero et al., with respect to a single coordinate system. The one step procedure is a model for obtaining a height z and a y coordinate from image coordinates (u, v) using models z=f(u, v) and y=g(u, v). In this case, f and g are correction data obtained through experiments. The one step procedure is introduced in “3-D Computer Vision using Structured light, Design, Calibration and Implementation Issues.” by De Piero, F. W., and Trivedi, M. T. in Advances in Computers 43 (1996), and thus a detailed description thereof is omitted.

In the coordinate measurement according to a preferred embodiment of the present invention, f is set to a quadratic function, g is set to a linear function, and z and y are obtained by the following Equation 1.

[u² v² uv u v 1]M=z

[u v 1]N=y [Equation 1]

In Equation 1, variables M and N can be calculated by the following Equation 2 that is configured using zᵢ, uᵢ, vᵢ measured by a correction platform, which will be described later.

$$[ \begin{matrix}{z}_{1} \\ … \\ {z}_{i} \\ … \\ {z}_{n}\end{matrix} ] = [ \begin{matrix}{u}_{1}^{2} & {v}_{1}^{2} & {u}_{1} {v}_{1} & {u}_{1} & {v}_{1} & 1 \\ … & … & & & & \\ {u}_{i}^{2} & {v}_{i}^{2} & {u}_{i} {v}_{i} & {u}_{i} & {v}_{i} & 1 \\ … & … & & & & \\ {u}_{n}^{2} & {v}_{n}^{2} & {u}_{n} {v}_{n} & {u}_{n} & {v}_{n} & 1\end{matrix} ] \vert \begin{matrix}{m}_{1} \\ … \\ {m}_{c }\end{matrix} \vert \qquad [ Equation 2 ]$$

A correction platform for performing model correction on the one step procedure in Equation 2 is shown in FIG. 5. As shown in FIG. 5, the correction platform is configured such that the origin of a coordinate system is placed on any one edge of the correction platform, the top surface of the correction platform is defined by an xy plane, and the correction platform is implemented by stacking up a plurality of plates. Since the plates are stacked up in the shape of stairs, they have different respective heights.

The lower left portion of FIG. 5 illustrates a view when z=zᵢ, that is, when the correction platform is viewed downwards in a perpendicular direction from a position above the correction platform at a predetermined height. Further, the lower right portion of FIG. 5 illustrates the case where several images having different heights z are overlaid on each other.

zᵢ corresponding to coordinates can be calculated from the image captured by the camera 300, and M can be calculated by the above Equation 2. In the case of y, N can be calculated using the same method.

After M and N have been calculated, y and z coordinates can be obtained from the image coordinates (u, v) using Equation 1. Since the x coordinate denotes a movement distance in the direction of movement of the web, it can be obtained from the encoder of a web roller. The x, y and z coordinates calculated in this way form three-dimensional coordinates at the measurement location.

The coordinate measurement unit 410 collects data from the camera 300 using internal measurement software, forms three-dimensional coordinates at the measurement location using the collected data through the above method, and displays an image of the light band using the three-dimensional coordinates. Preferably, the measurement software may be configured using Visual C++ and Pylon (the Basler camera interface wrapper).

Hereinafter, data collection and image display performed by the coordinate measurement unit 410 using the internal measurement software are described on the basis of the characteristic aspects of the present invention.

The data collection and image processing of the measurement software are preferably performed in a multithreaded process in an overlap mode. A grab thread is continuously implemented using a camera buffer. When the camera buffer is filled with images, the grab thread copies data to an image buffer, starts image processing, and then resumes grabbing. At this time, the image processing thread processes data present in the image buffer, and requests the display of the processed data from a software interface. While the image processing thread waits for a subsequent image, the message handling function of a window outputs requested data. The image processing and display procedure based on the above-described mechanism can minimize the operation time between successive images.

The display of the measurement software will be described below.

According to an embodiment of the present invention, data received by the coordinate measurement unit 410 from the camera 300 is implemented using an 8-bit grayscale matrix. In order to promptly display such a matrix as an image, a method of handling a memory bitmap as data and copying the memory bitmap to a screen can be used. In order to implement this method, the management of bitmap formatted data having image information is required.

In this data management process, in order to prevent memory from being reallocated for each frame, the same size and brightness information (8 bits) as that of a previous bitmap can be loaded from a hard disc to a fixed memory location when software is started. At this time, the camera 300 transmits captured data each time, and replaces image data at the fixed memory location with the transmitted data.

A graph of the two-dimensional section of the web 200 is preferably implemented to shorten the time required for the update of the two-dimensional section graph using a Polyline command required to simultaneously connect all points, instead of a LineTo command required to connect two points as a segment. In order to prevent the display from being flickered, it is preferable to use class CMemDC, instead of CDC.

An example of a display screen realized by the software in the above method is shown in FIG. 6.

Next, the image processing unit 420 functions to clarify the image of the two-dimensional section graph of the web 200, configured on the basis of the coordinates measured by the coordinate measurement unit 410.

In a preferred embodiment of the present invention, since unnecessary information is blocked from entering the background of the web 200 by the camera 300, image processing by the image processing unit 420 can be very simply performed using a Sobel operator represented by a separable 3×3 matrix, as shown in the following Equation 3.

$$\begin{matrix}f ( x , y ) = [ \begin{matrix}- 1 & - 2 & - 1 \\ 0 & 0 & 0 \\ 1 & 2 & 1\end{matrix} ] \\ = [ \begin{matrix}- 1 \\ 0 \\ 1\end{matrix} ] \times [ \begin{matrix}1 & 2 & 1\end{matrix} ] \\ = g ( x ) \times h ( y )\end{matrix} \qquad [ Equation 3 ]$$

In Equation 3, a convolution can be more promptly performed because the matrix is divided into two linear matrices g(x) and h(y). More preferably, a convolution is performed only in the region of a light band, formed by the laser beam on the web 200, thus shortening calculation time.

After image processing performed by the image processing unit 420, an image of the light band formed by the laser beam on the web 200 becomes clearer. Examples of an image, including an unclear laser line, and a clearer and brighter image, obtained after image processing, are shown in FIGS. 7 and 8, respectively.

Next, the image correction unit 430 corrects a distorted region of the image processed by the image processing unit 420.

The image of the light band formed by the laser beam on the web 200 may have various shapes according to the tension of the web 200. When the tension is high, the surface of the web is approximate to a straight line, and thus the section thereof can be regarded as a straight line. The straight line is set as a reference line, and the height of a wrinkle can be measured as the distance therefrom to the peak of the image of the light band.

However, since the precision of a digital image is limited, image correction for compensating for the curvatures of the image processed by the image processing unit 420 is performed in a preferred embodiment of the present invention, and this procedure will be described below.

First, in order to compensate for the curvatures of a curved image, a method of applying a Gaussian filter, having λᵣ (small curvature) and λ_{f} (large curvature) as cutoff values, twice is used. However, the Gaussian filter causes a twisted distortion on the edge of the image, similar to other image correction filters based on a convolution.

In order to correct the twisted distortion, a Gaussian regression filter, proposed by Brinkmann et al., is applied to the image in a preferred embodiment of the present invention. The twisted distortion can be prevented using a method of increasing the weighting function of the filter so that regions surrounding the lower portion of a Gaussian bell curve are always ‘1’ in the Gaussian regression filter.

Images, before and after the Gaussian regression filter is applied to the image processed by the image processing unit 420, are shown in FIGS. 9 and 10, respectively. In FIGS. 9 and 10, λ_{c}=1.5 mm and A_{f}=1.5 mm were used, the small cutoff λᵣ=1.5 mm functioning to make the shape of the image smooth to realize visual effects. In FIG. 10, it can be seen that, after Gaussian regression filtering has been performed, a twisted distortion is also corrected on the edge of the image.

Finally, the display unit 440 displays the image, clarified by the image processing unit 420, or the image, the distortion of which has been corrected by the image correction unit 430. Examples of the screen output on the display unit 440 are shown in FIGS. 11 and 12. FIG. 11 illustrates a bitmap image corrected by the image correction unit 430, and FIG. 12 illustrates an example of the distribution of the heights of web wrinkles in a direction perpendicular to the movement direction of the web 200. The heights of the wrinkles formed on the web 200 can be detected depending on the distances in the direction perpendicular to the movement direction of the web 200.

Further, in order to easily process an image of a light band by blocking information unnecessary for the measurement of wrinkles, a background element 500 can be installed in a direction opposite the direction, in which the laser generation device 100 is installed, around the location of the web. Such a background element 500 is preferably installed in a single color, such as black.

Although the preferred embodiments of the present invention have been disclosed for illustrative purposes, those skilled in the art will appreciate that the present invention is not limited to the construction and operation shown and described in this way, and various changes and modifications are possible, without departing from the scope and spirit of the invention. Therefore, it should be noted that all suitable modifications, changes and equivalents thereof belong to the scope of the present invention.

### INDUSTRIAL APPLICABILITY

As described above, according to the present invention, there is an advantage in that the results of reliable wrinkle measurement can be provided for a web, which is moving at high speed, in an R2R process.

According to the present invention, there is an advantage in that the results of wrinkle measurement can be provided in the form of three-dimensional coordinates, including a height coordinate, with respect to wrinkles on a web in an R2R process.

According to the present invention, the results of measurements of the shape information of wrinkles on a web can be displayed in real time in a R2R process.

1. A system for measuring wrinkles on a web in a Roll-to-Roll (R2R) process, comprising:
a laser generation device (100) for projecting a laser beam, emitted in a linear shape, onto a surface of a web (200), which is stopped or moving;
a camera (300) for capturing a band of light, formed when the laser beam generated by the laser generation device (100) is projected onto the surface of the web (200), and transmitting image data of the captured light band; and
a measurement device (400) for calculating coordinates of an arbitrary location on the web (200) on a basis of the image data transmitted from the camera (300), processing an image of the light band on a basis of the calculated coordinates, and displaying the processed image.

2. The system according to claim 1, wherein the laser beam is a diode laser beam.

3. The system according to claim 1, wherein the laser beam is projected in a direction perpendicular to the surface of the web (200).

4. The system according to claim 1, further comprising a background element (500) installed opposite the laser generation device (100) around the surface of the web (200) and configured to block information unnecessary for measurement of a wrinkle on the web.

5. The system according to claim 1, wherein the measurement device (400) comprises:
a coordinate measurement unit (410) for collecting image data from the camera (300) using internal measurement software, calculating three-dimensional coordinates at a measurement location using the collected image data, and forming the image of the light band;
an image processing unit (420) for removing noise from the image of the light band, thus clarifying the image;
an image correction unit (430) for correcting a distorted region of the image, from which the noise is removed and which is clarified; and
a display unit (440) for displaying the image, in which the distorted region is corrected.

6. The system according to claim 5, wherein the image processing unit (420) removes noise from the image of the light band using a Sobel operator represented by a separable 3×3 matrix, as shown in the following equation, thus clarifying the image:
$$f ( x , y ) = [ \begin{matrix}- 1 & - 2 & - 1 \\ 0 & 0 & 0 \\ 1 & 2 & 1\end{matrix} ] = [ \begin{matrix}- 1 \\ 0 \\ 1\end{matrix} ] \times [ \begin{matrix}1 & 2 & 1\end{matrix} ] = g ( x ) \times h ( y )$$

7. The system according to claim 1, wherein calculation of coordinates performed by the measurement device (400) is performed using a one step procedure.

8. The system according to claim 7, wherein the one step procedure is performed by the following equations:
$$[ \begin{matrix}{u}^{2} & {v}^{2} & uv & u & v & 1\end{matrix} ] M = z \\ [ \begin{matrix}u & v & 1\end{matrix} ] N = y \\ [ \begin{matrix}{z}_{1} \\ … \\ {z}_{i} \\ … \\ {z}_{n}\end{matrix} ] = [ \begin{matrix}{u}_{1}^{2} & {v}_{1}^{2} & {u}_{1} {v}_{1} & {u}_{1} & {v}_{1} & 1 \\ … & … & & & & \\ {u}_{i}^{2} & {v}_{i}^{2} & {u}_{i} {v}_{i} & {u}_{i} & {v}_{i} & 1 \\ … & … & & & & \\ {u}_{n}^{2} & {v}_{n}^{2} & {u}_{n} {v}_{n} & {u}_{n} & {v}_{n} & 1\end{matrix} ] \vert \begin{matrix}\begin{matrix}{m}_{1} \\ …\end{matrix} \\ {m}_{c}\end{matrix} \vert$$
where z is a height of the wrinkle on the web, y is a distance in a coordinate system, set on the surface of the web, in a direction perpendicular to a movement direction of the web, zᵢ, uᵢ and vᵢ are three-dimensional coordinates set by a correction platform based on the one step procedure.

9. The system according to claim 5, wherein the image correction unit (430) compensates for curvatures of the image, from which the noise is removed and which is clarified, by applying a Gaussian filter to the image.

10. The system according to claim 9, wherein a Gaussian regression filter is used to correct a twisted distortion after the Gaussian filter has been applied.
